(19) United States
(12) Patent Application Publication
(10) Pub. No.: US 2017/0059199 A1
(43) Pub. Date: Mar. 2, 2017

(54) Environmentally Friendly Heating Ventilation and Air Conditioning System

(71) Applicants: Yulong Zhang, Morgan Hill, CA (US); Liang Jin, Santa Clara, CA (US)

(72) Inventors: Yulong Zhang, Morgan Hill, CA (US); Liang Jin, Santa Clara, CA (US)

(21) Appl. No.: 15/248,696

(22) Filed: Aug. 26, 2016

Related U.S. Application Data
(60) Provisional application No. 62/211,495, filed on Aug. 28, 2015.

(51) Int. Cl. F24F 11/08; B64D 13/08; B60H 1/00; F24F 13/28; F24F 11/00

(52) U.S. Cl. CPC F24F 11/08; F24F 13/28; F24F 11/0079; F24F 11/008; F24F 11/0012; B60H 1/00835; B60H 1/00878; B64D 13/08; F24F 2011/0013; F24F 2011/0016; F24F 2011/0075; B64D 2013/0651

(57) ABSTRACT

An air circulation system for a building or other enclosed space that includes an heating, venting and air conditioning (HVAC) unit and a first air duct connecting the HVAC unit with the interior of the building. The system also includes a second air duct connecting the exterior of the building with its interior. A fan or secondary unit directs and moves air from outside of the building to inside the building when a controller determines via one or more sensors that an outside condition is preferable to a condition inside the building. The system also may be used in vehicles such as in ground-based vehicles including public transports, and in aircraft.

This application claims the benefit and filing date of U.S. provisional patent application having Ser. No. 62/211,495 and which was filed on 28 Aug. 2015.

### BACKGROUND

Field

The present invention relates generally to HVAC systems, and specifically to a control system and related components for bypassing heating and air conditioning components based on an outdoor condition.

Related Art

Many heating, ventilation and air conditioning (HVAC) systems used in residential and commercial applications use a single HVAC unit. HVAC systems have essentially remained the same for decades. HVAC units circulate air within a single building. The HVAC unit is controlled by one or more thermostats located within the building.

There are disadvantages to this type of system including inefficient energy use, high operating costs and lack of flexibility in controlling the unit. Even though a single HVAC unit may service several zones, one zone may end up cooler or hotter than another within the building. A typical HVAC unit has few control variables and few operating states. For heating, the HVAC unit can heat the air at one setting. Warm air is circulated at a single fan speed while a furnace heats the air in a single “on” state until a temperature reading of the air inside the building near a sensor exceeds the thermostat setting. For cooling, a refrigerator cools the air at a single operating state to a fixed temperature and the HVAC unit circulates cool air at this one temperature until a temperature measured inside the building near a sensor falls below a thermostat setting.

While zoned systems allow for more control over HVAC operation, zoned HVAC systems are expensive to purchase and install, and complicated to configure and maintain. The cost and complexity of zoned HVAC systems are barriers to use of such systems.

### SUMMARY

Embodiments and techniques described herein relate to an improved and more environmentally friendly system for circulating air for a dwelling, building, or other enclosed area such as a train, a bus, an automobile, an airplane and so forth. According to a first aspect of the disclosure, an air circulation system includes an air conditioning unit and a first air duct connecting the air conditioning unit with the interior of the building. The system also includes a second air duct connecting the exterior of the building with its interior. A fan blows air from outside of the building inside the building when a controller determines via sensors that an outside condition is preferable to a condition inside the building. For example, the controller may determine that the outside air temperature is cooler than a temperature of air inside the building.

This Summary is provided to introduce a selection of concepts in a simplified form that are further described herein. This Summary is not intended to identify key or essential features of the claimed subject matter, and thus is not intended to be used to limit the scope of the claimed subject matter.

### BRIEF DESCRIPTION OF THE DRAWINGS

While the appended claims set forth the features of the subject matter with particularity, the following is a summary of the drawings that accompany the text. Throughout, like numerals generally refer to like parts. Unless specifically indicated, the components and drawings are not shown to scale or in proportion to one another.

FIG. 1 illustrates a heating, ventilating, and air conditioning (HVAC) system according to the known art.

FIG. 2 illustrates a first embodiment of an air circulation system that takes advantage of a condition exterior to a building.

FIG. 3 illustrates another embodiment of an air circulation system that takes advantage of multiple conditions exterior to a building.

FIG. 4 illustrates a second embodiment of an HVAC air circulation system that takes advantage of a condition change exterior to a vehicle.

### DETAILED DESCRIPTION

Overview. A conventional heating, ventilating, and air conditioning (HVAC) system can be improved with the addition of components to allow the HVAC system to respond to external conditions and to use air external to a building to control conditions inside of the building. Components can be operated to bypass conventional HVAC components based on one or more outdoor conditions.

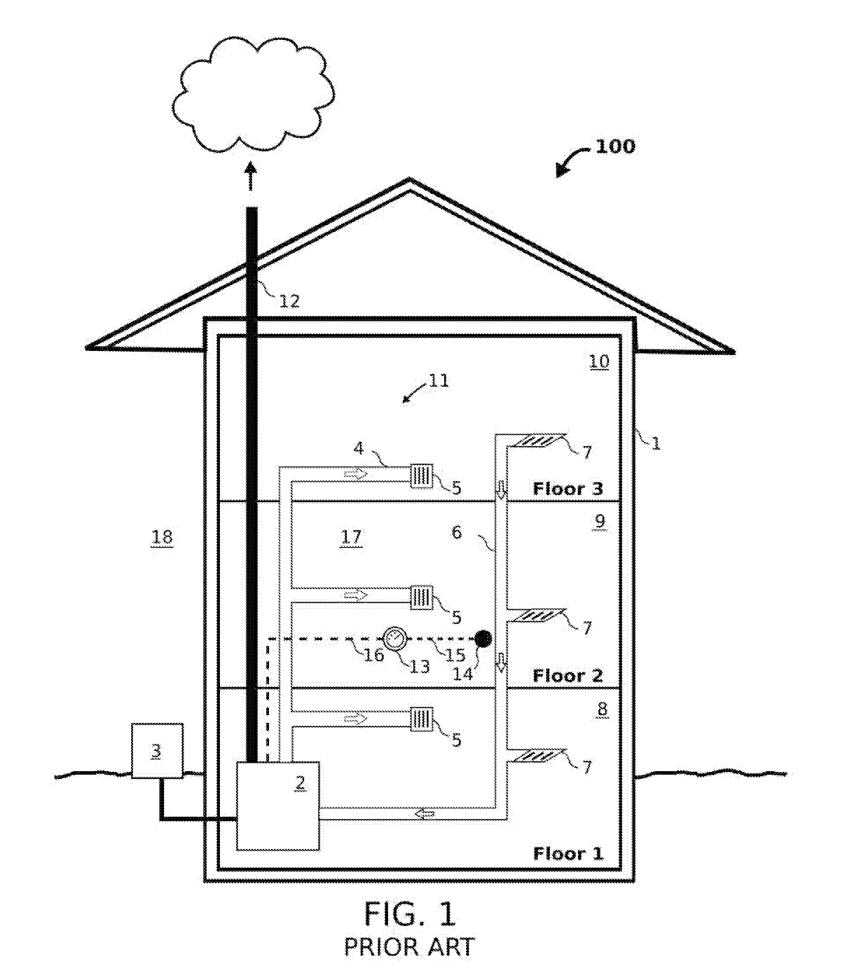

FIG. 1 illustrates an HVAC system according to the known art. In FIG. 1, according to a first embodiment 100, a building 1 encloses an interior space 11. The interior space 11 may be divided into one or more regions or HVAC zones such as a first floor 8, a second floor 9, and a third floor 10. A single HVAC unit 2 is connected with a cooling unit 3 which exhausts heat outside of the building 1. The HVAC unit 2 is connected by a control line 16 to a thermostat or controller 13. The controller 13 is connected by a sensing line 15 to a temperature sensor 14. The controller 13 operates the HVAC unit 2 to heat or cool the air. Intake air is accepted through intake vents 7 located in each zone 8-10. Intake air passes from the intake vents 7 through air intake lines or intake ducts 6 to the HVAC unit 2.

The HVAC unit 2 distributes reconditioned air through distribution ducts 4 to outlet vents 5 which are locate in the one or more HVAC zones 8-10. When heating, the HVAC unit 2 sends exhaust fumes upward and out of the building 1 through a flue 12.

FIG. 1 illustrates some of the many limitations of this scheme. One limitation is due to the controller 13 not having any connection (e.g., data, numbers, input) from a condition of the building 1 or a condition of the exterior 18 (e.g., ambient air humidity, ambient air temperature, ambient wind condition, incident light condition). For example, after a certain point during an end of daylight hours, the building 1 has absorbed heat from being exposed to direct sunlight but is no longer absorbing heat from the sun. The roof and walls of the building 1 are higher in temperature than the temperature of the air of the exterior 18 and higher in temperature than the temperature of the setpoint of the controller 13. The controller 13 has no data from any aspect of the environment (e.g., building 1, exterior 18) from which to take corrective action to adjust the temperature of the internal air 17 of the building.

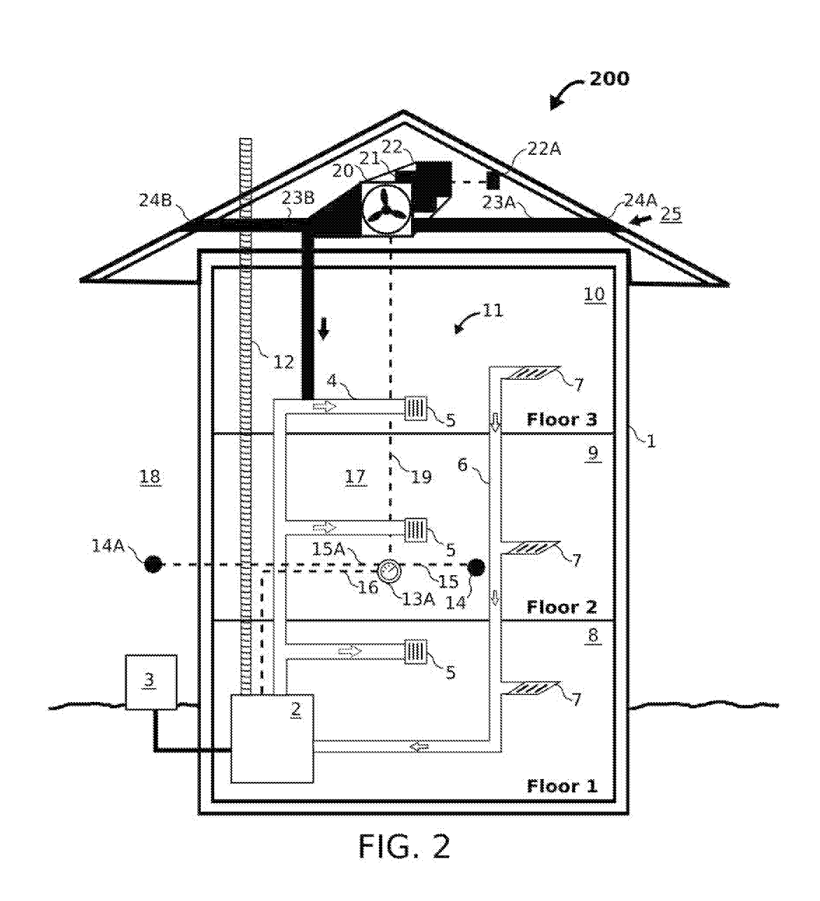

FIG. 2 illustrates an embodiment of an air circulation system according to a second embodiment 200 that takes advantage of a condition change exterior to a building 1. In FIG. 2, a building 1 encloses an interior space 11. The interior space 11 is divided into a plurality of regions or HVAC zones such as a first floor 8, a second floor 9, and a third floor 10. In addition to a first temperature sensor 14, the controller 13A is also connected via a second connection or second sensing line 15A to a second sensor 14A. The second sensor 14A senses a condition outside of the building 1 and provides data to the controller 13A. For example, the second sensor 14A is a temperature sensor and provides temperature data to the controller 13A. According to another example, the second sensor 14A is located above a roofline to make sure that an outside condition is accurately detected. Further, the second sensor 14A may be matched to and be located near an inlet 24A that is above a roofline so that fresh, cool air 18 or 25 may be drawn into the building even when air near the ground may be hot due to reflection and radiation of heat from the sun warming the air near the ground (at a ground level floor in reference to the building 1).

According to one scenario, over a portion of a day, the HVAC unit 2 has been cooling the air 17 inside the building 1 in response to the outside air temperature being in excess of the temperature of the inside air 17. The HVAC unit 2 has been exhausting heat through the cooling unit 3. Operation of the HVAC unit 2 and the cooling unit 3 incurs costs. Over time the outside temperature cools. At a point late in the day, the temperature of the outside air 18 falls below the temperature of the inside air 17. The controller 13A recognizes this condition based on a comparison of the outside air temperature with the inside air temperature. At this point, instead of operating the HVAC unit 2 through connection line 16, the controller 13A turns off the HVAC unit 2 and the cooling unit 3, and the controller 13A begins to operate a second unit 20. The controller 13A is connected to the second unit 20 through a connection line 19.

The second unit 20 includes a mechanism to move outside air 18 directly into the interior of the building 1. For example, the second unit 20 moves air from outside of the building by pulling cool air 25 into an inlet 24A, through intake one or more intake ducts 23A, and into the distribution ducts 4. Cool outside air 25 passes into the building 1 through the various existing exit vents 5. From a perspective of occupants (not illustrated in FIG. 2), nothing has changed: cool air 25 is delivered to the building 1. From an operational perspective, only costs associated with operation of the second unit 20 are incurred.

The second unit 20 may include a fan or other air moving element. According to another embodiment, the second unit 20 includes a first fan for moving cool air and a second fan for moving hot air. Either cool or hot air may be drawn into the building. The first fan may be located in a first location, and the second fan may be located in a second location distant from the first location. For example, a first fan is located near a roofline, and a second fan is located at or near the ground.

The second unit 20 may include an air filter 21 such as a high efficiency particular air (HEPA) filter or a UV air filter. The second unit 20 also may include a moisture controller 22. The second unit 20 may include an additional control system 22A. According to one implementation, the control system 22A controls one or more qualities or characteristics of incoming outside air 18 to adapt the incoming outside air 18 fed into the building 1 through the first inlet 24A or through the second inlet 24B via a second secondary intake duct 23B. For example, the additional control system 22A may operate the moisture controller 22 in the event that the incoming outside air 18 is excessively humid. In this example, the control system 22A operates the moisture controller 22 to reduce the humidity of the incoming outside air 18. The second control system 22A may be operatively coupled to the first controller 13A. For example, the second control system 22A may share and exchange data from sensors with the first controller 13A. The second control system 22A also may share and exchange control data with the first controller 13A.

According to one alternative, the second unit 20 is illustrated in FIG. 2 in the attic space of the building 1, but may be located in one or more other places such as proximate to the cooling unit 3 (exterior to the building 1), inside a first floor 8 (interior to the building 1).

According to another alternative, instead of the second unit 20 moving cool air into the existing ducts 4, the second unit 20 moves cool outside air directly into one or more interior HVAC zones without using any of the existing ducts 4. For example, the second unit 20 delivers cool outside air through secondary duct 23A directly into the HVAC zone of the third floor 10.

According to another alternative, instead of bringing air in from a first inlet 24A, the controller 13A brings cool air into the building 1 through a second inlet 24B via a second secondary intake duct 23B. According to this alternative, the controller 13A may be able to determine that outside air on a first side of the building 1 may be cooler than on a second side of the building 1.

According to yet another alternative, an outside air temperature must fall a temperature delta below an interior air temperature before the secondary unit 20 is operated. For example, the controller 13A is configured with instructions to detect the temperature of the outside air 18. At a certain point in time, when the outside air temperature falls to 60 degrees F. (which is 10 degrees below an air temperature setpoint (e.g., keep the inside air at 70 deg. F), the controller 13A turns off HVAC unit 2, and operates secondary unit 20. The controller 13A then brings cool air 25 into the interior of the building 1 to cease use of the cooling unit 3.

The principles and embodiments described above in relation to a structure or building may also apply to a mobile dwelling or mobile interior space such as to the interior of a ground-based vehicle or aircraft. According to conventional equipment, one limitation of HVAC units in vehicles is the lack of meaningful input of environmental conditions outside of the vehicle to a controller that can influence a condition inside of the vehicle. For example, an existing component may provide to a vehicle operator a visual indication of temperature outside of the vehicle, but temperature data is not provided to a controller associated with or operating to influence the interior of the vehicle.

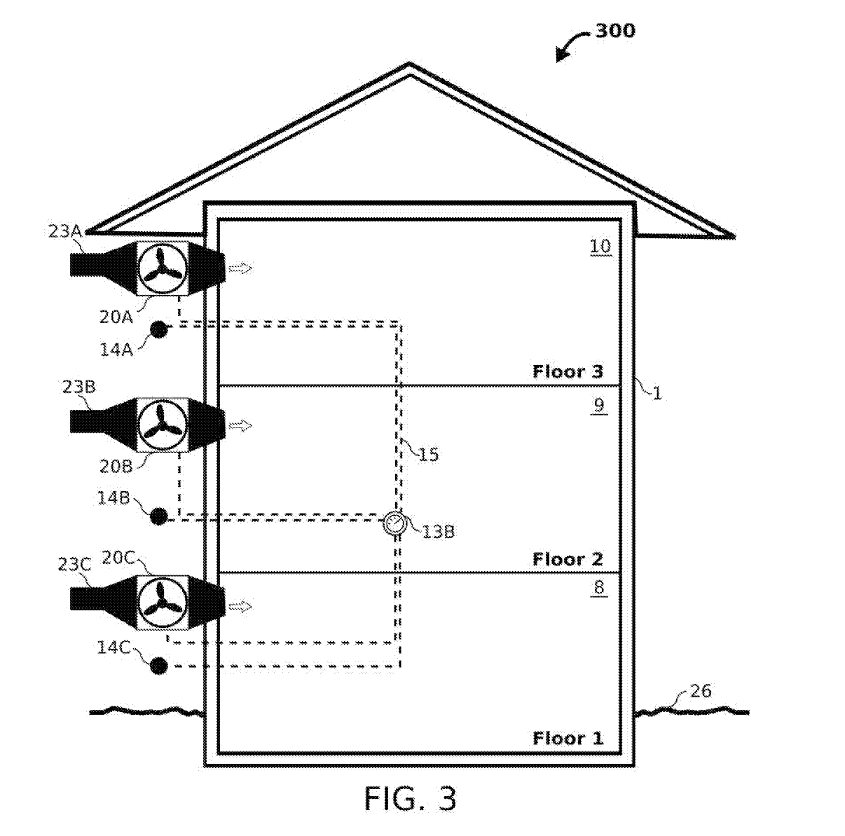

FIG. 3 illustrates another embodiment of an air circulation system that takes advantage of multiple conditions exterior to an enclosed space. In FIG. 3, a set of second units 20A, 20B and 20C are shown. According to one implementation, each of the second units 20A-C is a small unit for serving a single HVAC zone such as a room or a floor (e.g., first floor 8, second floor 9, third floor 10). The controller 13B may be connected to each of the second units 20A-C.

The controller 13B may be programmed with instructions to serially bring each of the second units 20A-C into service as cool exterior air becomes available to the controller 13B. The controller 13B determines that each second unit 20A, 20B and 20C becomes available by evaluating a value or a datum from a respective outside sensor 14A, 14B and 14C. Alternatively, the controller 13B may evaluate data from all second units 20A-C to determine whether to operate a first second unit 20A, a second second unit 20B or a third second unit 20C, or even to operate a combination of second units 20A-C. According to another variation, the controller 13B may operate a first second unit 20A in a first mode (e.g., fan speed, time duration) and operate a second second unit 20B in a second mode (e.g., fan speed, time duration) based on a first condition sensed at a first sensor 14A relative to a second condition sensed at a second sensor 14B—the first sensor 14A located at a first location relative to the building 1 and the second sensor 14B located at a second location relative to the building 1. The location may different in terms of vertical placement above the ground 26, or may be on a first side or second side of the building 1 with respect to incident light from the sun, or may be on a first side or second side of the building 1 with respect to a wind condition in the area of the building 1.

A determination to operate one or more of the second units 20A-C may depend upon one, two or more exterior conditions. While a single sensor 14A-C is shown for each of the second units 20A-C, multiple sensors may be installed and made available to the controller 13B in order to determine whether to operate any particular second unit 20A, 20B and 20C.

According to an illustrative scenario, each of the sensors 14A, 14B and 14C are located a respective first, second and third distance above the ground 26. Preferably, there is at least one outside sensor for each of the second (secondary) units 20A, 20B and 20C. Each sensor 14A, 14B and 14C may be associated with one of each of the several respective HVAC zones 10, 9 and 8. If a ground air temperature about vertically proximate to a respective HVAC zone 8 remains hot, and a third floor outside sensor provides data that outside air near the third floor and third HVAC zone 10 is cooler than inside air, then the controller 13B activates and operates a second unit such as second unit 20A to pull cool air into the building from a location near and exterior to the third floor 10.

Other physical configurations and scenarios are possible. Sensors may sense, track and communicate data related to temperature, humidity, wind condition, precipitation, incident light and so forth. Secondary units may be placed inside or outside of a building or dwelling. Secondary units may circulate air, water or some other medium, or may control another variable other than temperature. For example, a second unit may control a humidity of air circulated in a primary unit.

Turning to another situation—there has been a distinctive lack of connection (e.g., data, values or numbers from sensors) to a condition of the vehicle or to a condition exterior to the vehicle (e.g., windshield temperature, ambient air humidity, ambient air temperature, ambient wind condition, incident light condition). Consider an illustrative scenario. Toward the end of daylight hours, a vehicle may have absorbed heat during the afternoon due to exposure to direct sunlight but the vehicle is no longer absorbing heat from the sun. The interior seats, roof, door panels and so forth of the vehicle would be significantly higher in temperature than the temperature of the air exterior to the vehicle. An HVAC unit such as an air conditioning unit (including a controller) inside the vehicle would have no data from any aspect of the environment (e.g., surface inside the vehicle, exterior air temperature), other than the air temperature inside of the vehicle, from which to take corrective action to adjust the interior air temperature.

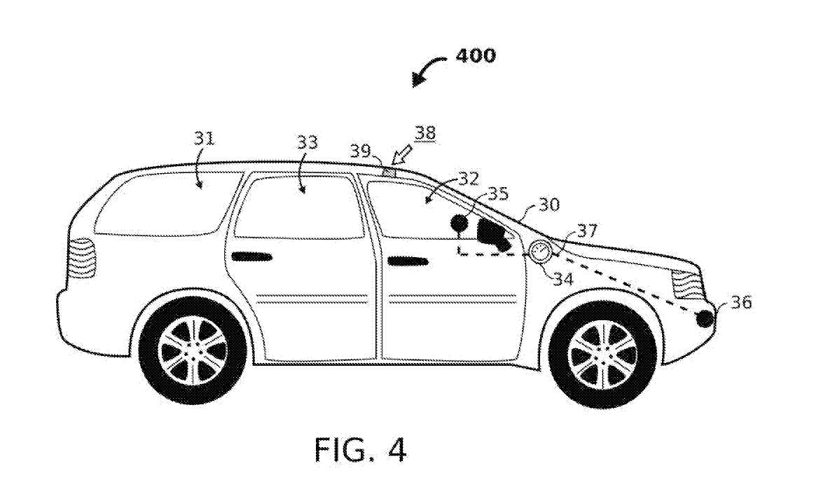

FIG. 4 illustrates another embodiment 400 of an HVAC air circulation system that takes advantage of a condition change exterior to a vehicle. In FIG. 4, a vehicle 30 encloses an interior space 31. The interior space 31 is divided into a plurality of regions or HVAC zones such as a first region 32 (e.g., front seats, trunk) and a second region 33 (e.g., middle seats). A controller 34 is coupled to a first sensor 35 and coupled to a second sensor 36 such as via a respective sensing line 37 or wireless connection. The first sensor 35 and the second sensor 36 may be temperature sensors, pressure sensors, humidity sensors, or other kind of sensor. The first sensor 35 senses a condition inside the vehicle 30. The second sensor 36 senses a condition outside of the vehicle 30 such as the air temperature or humidity at the front of the vehicle 30. The sensors 35, 36 provide data to the controller 34. According to another example, the second sensor 36 is located above a roofline of the vehicle 30 to make sure that an outside condition is accurately detected. Further, the second sensor 36 may be matched to and be located near an inlet 39 that is near or above a roofline so that fresh, cool air 38 may be drawn into the vehicle even when air inside of an engine compartment may be hot due to heat from the sun or engine warms the air above a setpoint of the controller 34.

According to one scenario, during operation in daylight, the HVAC unit (not shown) of the vehicle 30 keeps the interior 31 of the vehicle 30 cool in response to the outside air temperature being in excess of the temperature of the inside air. The vehicle HVAC unit exhausts heat to the exterior of the vehicle. Even if it is somewhat energy efficient, operation of the HVAC unit incurs costs. When the temperature of the outside air 38 falls below the temperature of the air inside the vehicle. The controller 34 recognizes this condition based on a comparison of the outside air temperature with the inside air temperature. At this point, instead of operating the HVAC unit, the controller 34 turns off the HVAC unit and opens a specially designed and positioned inlet 39.

While shown near the roofline of the vehicle 30, the inlet 39 may be created and installed anywhere in the vehicle 30 where outside air 38 is available. For example, the inlet may be located near or at the bottom of the cabin and under the vehicle chassis near the road. In such location, the inlet 39 can take advantage of outside air 38 flowing under the vehicle. Alternatively, while not shown in FIG. 4, the inlet may be installed at the front of the vehicle 30 and accepts fresh air into a conduit that passively draws air 38 from the front of the vehicle 30 into the interior 31 as the vehicle moves forward. While shown as a single inlet 39, multiple inlets may be installed and each independently operated by the controller 34. A sensor may be installed proximate to or inside of each inlet 39 so that the controller 34 may take advantage of various local air conditions that are exterior to the vehicle 30. Preferably, the inlet 39 is operated without any intervention or action on the part of a vehicle operator.

While not shown, the inlet 39 may include a conduit, a fan, a filter and sound baffles to reduce or eliminate detectable sound associated with introducing fresh outside air 38 into the interior of the vehicle. While not shown, the system in FIG. 4 may include an active fan or blower that exhausts interior air to the exterior of the vehicle 30 while the inlet 39 brings in a sizable quantity of fresh air on a per unit of time basis. From a perspective of occupants (not illustrated in FIG. 4), nothing has changed: cool air is delivered to the interior 31 of the vehicle 30. From an operational perspective, only costs associated with operation of the inlet 39 are incurred. While the system has been shown in FIG. 4 in relation to a ground-based vehicle, a similar system may be installed and operated in cars or separate compartments of a train, in a bus or separate portions of a bus, in an aircraft or separate portions of an aircraft, and so forth.

Conclusion. In the previous description, for purposes of explanation, specific details are set forth in order to provide an understanding of the invention. It should be apparent, however, to one skilled in the art that the invention can be practiced without these specific details. In other instances, structures, devices, systems and methods are shown only in block diagram form in order to avoid obscuring the invention.

Reference in this specification to “one embodiment”, “an embodiment”, or “implementation” means that a particular feature, structure, or characteristic described in connection with the embodiment or implementation is included in at least one embodiment or implementation of the invention. Appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It should be evident that the various modification and changes can be made to these embodiments without departing from the broader spirit of the invention. In this technology, advancements are frequent and further advancements are not easily foreseen. The disclosed embodiments may be readily modifiable in arrangement and detail as facilitated by enabling technological advancements without departing from the principles of the present disclosure.

We claim:

1. An air circulation system for a dwelling, the system comprising:
an heating, ventilation and air conditioning (HVAC) unit including an air circulator configured to circulate temperature adjusted air within the dwelling;
a first air duct connecting the HVAC unit with a first interior portion of the dwelling;
a second air duct connecting an exterior of the dwelling with a second interior portion of the dwelling;
a fan in fluid connection with the second air duct, wherein the fan is configured to draw air exterior to the dwelling into the second interior portion of the dwelling through the second air duct;
a first sensor located interior to the dwelling for sensing an interior condition of the dwelling; and
a controller in electronic configuration with the first sensor and the fan, wherein the controller is configured with instructions to:
receive a value associated with a first condition exterior to the dwelling;
receive a value from the first sensor;
operate the HVAC unit when the first condition value relative to the first sensor value is in a first relationship; and
operate the fan when the first condition value relative to the first sensor value is in a second relationship.

2. The air circulation system of claim 1, wherein the second interior portion of the dwelling is the first air duct.

3. The air circulation system of claim 1, wherein the condition exterior to the dwelling is temperature.

4. The air circulation system of claim 1, wherein the condition exterior to the dwelling is humidity.

5. The air circulation system of claim 1, wherein the fan is mounted at least 3 feet above the ground.

6. The air circulation system of claim 1 further comprising:
a second sensor in electronic communication with the controller and located exterior to the dwelling, wherein the second sensor is configured to provide the value associated with the first condition.

7. The air circulation system of claim 6, wherein the second sensor is located above a roofline of the dwelling.

8. The air circulation system of claim 1 further comprising:
a second sensor in electronic communication with the controller and located exterior to the dwelling at a first distance above a ground floor of the building;
a third sensor in electronic communication with the controller and located exterior to the dwelling at a second distance above a ground floor of the building, wherein the third sensor is configured to provide values associated with a second condition to the controller;
and wherein the controller is further configured with instructions to:
operate the fan in a first mode when the first condition value relative to the second condition value is in a first relationship; and
operate the fan in a second mode when the first condition value relative to the second condition value is in a second relationship.

9. The air circulation system of claim 8, wherein the first mode includes a first fan speed, and wherein the second mode includes a second fan speed.

10. The air circulation system of claim 8, wherein the system further includes an outlet valve that controls flow of outside air to either a first location in the dwelling or a second location in the dwelling, wherein the first mode includes a first valve position directing exterior air to the first location, and wherein the second mode includes a second valve position directing exterior air to the second location.

11. The air circulation system of claim 10, wherein the first location is an attic space within the dwelling.

12. The air circulation system of claim 10, wherein the first location in the dwelling is in a same room as the second location in the dwelling, and wherein the second location is separated by at least 3 vertical feet above the first location.

13. The air circulation system of claim 1, wherein the dwelling is a ground-based vehicle.

14. The air circulation system of claim 1, wherein the dwelling is an aircraft.

15. The air circulation system of claim 1, wherein the temperature adjusted air is cool air.
